(19) United States
(12) Patent Application Publication
(10) Pub. No.: US 2007/0239505 A1
(43) Pub. Date: Oct. 11, 2007

(54) Abstract execution model for a continuation-based meta-runtime

(75) Inventors: Dharma K. Shukla, Sammamish, WA (US); Robert B. Schmidt, Woodinville, WA (US); Mayank Mehta, Redmond, WA (US); Akash J. Sagar, Bellevue, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/393,345

(22) Filed: Mar. 30, 2006

(51) Int. Cl. G06F 9/46

(52) U.S. Cl. 705/8

(57) ABSTRACT

Providing a workflow engine for virtualizing a managed execution environment. The workflow engine executes a workflow based on an automaton and methods associated therewith. The workflow engine captures continuations associated with the executing workflow to enable modeling of real-world processes.

### BACKGROUND

Existing systems attempt to model business processes or other real-world interactions between autonomous agents via high-level workflows. However, the workflows may vary in a variety of dimensions such as (a) execution and modeling complexity, (b) knowledge of the structure of the flow at design time, (c) statically defined or ad-hoc/dynamic. (d) ease of authoring and editing the flow at various points in its lifecycle, and (e) weak or strong association of business logic with the core workflow process. Existing workflow models fail to accommodate all these factors.

Further, most existing workflow models are based on either language-based approaches (e.g., BPEL4WS, XLANG/S, and WSFL) or application-based approaches. Language based approaches are high-level workflow languages with a closed set of pre-defined constructs which help model the workflow process to the user/programmer. The workflow languages carry all of the semantic information for the closed set of constructs to enable the user to build a workflow model. However, the languages are not extensible by the developers and represent a closed set of primitives that constitute the workflow model. The languages are tied to the language compiler shipped by the workflow system vendor. Only the workflow system product vendor may extend the model by extending the language with a new set of constructs in a future version of the product. This often requires upgrading the compiler associated with the language. In addition, the languages usually do not declaratively expose or define functions or operations that can be readily and efficiently used by other programs.

Application based approaches are applications that have the workflow capabilities within the application to solve a domain specific problem. These applications are not truly extensible nor do they have a programmable model.

### SUMMARY

Embodiments of the invention model real-world processes in a workflow. In an embodiment, the invention defines an automaton for association with an activity in a workflow. A meta-runtime engine, virtualizing a managed execution environment having a fixed functionality, executes a program fragment including the activity based on the defined automaton. In response to receiving a suspension signal directed to the executing program fragment, the meta-runtime engine determines continuation data associated with the program fragment and releases any resources associated with the program fragment.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating an exemplary operating environment for aspects of the invention.

FIG. 2 is an exemplary block diagram illustrating a continuation-based workflow framework according to an embodiment of the invention.

FIG. 3 is an exemplary block diagram illustrating a workflow according to an embodiment of the invention.

FIG. 4 is a diagram illustrating a hierarchical structure of a workflow activity according to an embodiment of the invention.

FIG. 5 is a diagram illustrating an exemplary state automaton for an activity according to an embodiment of the invention.

FIG. 6 is a block diagram illustrating an exemplary system for processing workflow activities according to an embodiment of the invention.

FIG. 7 is an exemplary flow chart illustrating operation of an abstract execution model for a continuation-based runtime.

Corresponding reference characters indicate corresponding parts throughout the drawings.

### DETAILED DESCRIPTION

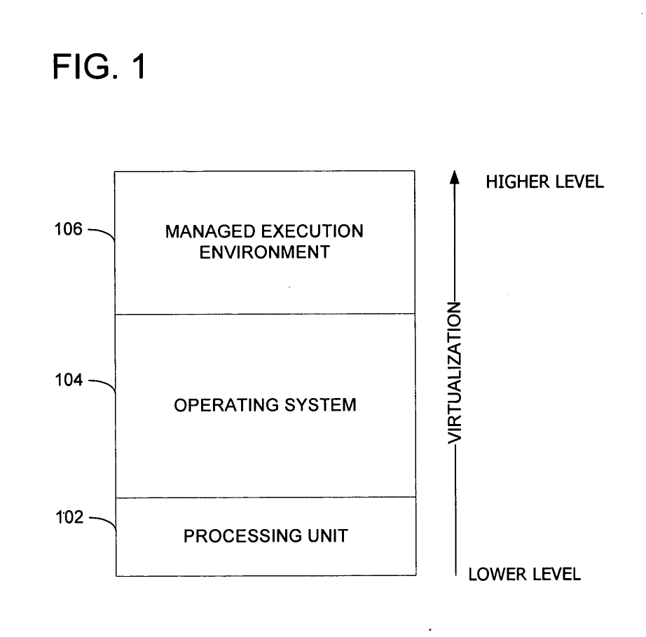

Referring first to FIG. 1, a block diagram illustrates a typical programming paradigm for modeling process-centric activities in a workflow. In this figure, the diagram shows a three-level virtualization model with a managed execution environment 106 at the highest level virtualizing an operating system 104. The managed execution environment 106 virtualizes the execution of a program executing in the environment 106 in terms of an abstract stack machine that may be implemented independent of the processor architecture of a computing device. The operating system 104 virtualizes a processing unit 102 at the lowest level. Programs at the managed execution environment 106 level lack the ability and efficiency to accommodate complex interactions between processes in a workflow due to the fixed functionality available in the managed execution environment 106. The managed execution environment 106 also includes various strict requirements unsuitable for handling the complexity and capability of workflows modeling real-world workflows. Further, the programming codes or routines in the operating system 104 are dependent on the type or configuration of the processing unit 102 and the type of computing architecture (e.g., compatible with IBM brand personal computers, APPLE brand personal computers, or other systems) among other constraints. In addition, programming languages typically require hardware-specific data structures such as a stack, heap, or thread for the operating system 104 to function properly.

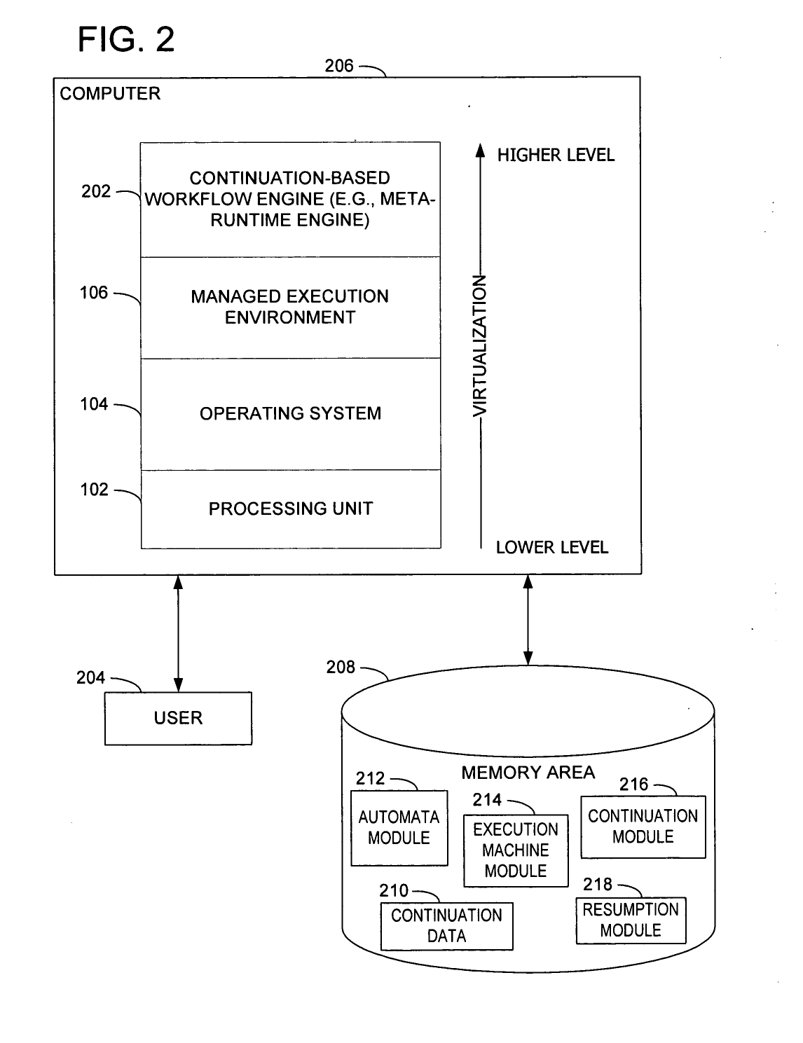

Referring next to FIG. 2, aspects of the invention include a continuation-based workflow engine 202, meta-runtime engine, or other framework virtualizing the managed execution environment 106. The workflow includes a hierarchical composition of activities with each activity representing a unit of work. The workflow engine 202 provides an asynchronous, abstract model of execution of the operation codes (op-codes) or the activities in the workflow representing real-world processes. The workflow engine 202 is a continuation-based runtime that is capable of suspending the programs and resuming them at any point during the execution cycle. While an activity is domain-specific, the workflow engine 202 is agnostic of domain specificity. Moreover, the workflow engine 202 knows nothing about a specific control flow pattern that is packaged in terms of an activity. As such, the execution model provided by aspects of the invention is abstract. Further, while the entire workflow instance may logically run for an arbitrary amount of time (e.g., days, months, or years), the activities associated with the workflow may perform short-lived work and yield in a co-operative multitasking manner. The abstract execution model of aspects of the invention allows the workflow engine 202 to suspend an instance in the middle of execution and/or evict it from memory and resume it in the future. The workflow engine 202 manages such operations across program passivation.

In one embodiment, the workflow engine 202 operates to virtualize one or more of the following aspects of the managed execution environment 106: domain-specific op-codes, a thread, a synchronization primitive, an execution machine, an object lifetime, a source format, an exception, a fault, fault propagation, and fault handling. For example, aspects of the invention enable users to write custom op-codes in terms of custom activities. In general, the workflow engine 202 uses a thread, a stack, and/or a heap from the managed execution environment 106. With the capability to execute programs written in any programming language and composed in any file format, the workflow engine 202 enables program developers to design programs without compromise. By defining activities representing workflow tasks or processes as the base class to be executed by the workflow engine 202, aspects of the invention enable developers to easily and efficiently build domain specific op-codes without adhering to the rigid, hard-coded, inflexible, and fixed set of functions or activities classes in the managed execution environment 106. The op-codes may be specific to the healthcare industrial, financial industry, or other domains. The workflow engine 202 in FIG. 2 may be any continuation-based runtime layered on top of any existing execution framework (e.g., the managed execution environment 106, operating system 104, or processing unit 102 in FIG. 1) that enables the modeling of continuations and various aspects thereof to allow the programmer to model complex and dynamic control flow patterns. Aspects of the invention enable the definition of activities in any fashion or representation (e.g., a flow chart, a diagram, a numbered description, or the like).

Continuations may be used to model complex and dynamic control flow patterns. A continuation represents a program frozen in action and may include a single functional object containing the state of a computation. When the object is evaluated, the stored computation may be restarted where it left off. In solving certain types of problems, it can be a great help to be able to save the state of a program and restart it later. In multiprocessing, for example, a continuation conveniently represents a suspended process. In nondeterministic search programs, a continuation can represent a node in the search tree.

While the managed execution environment 106 creates a common, yet fixed, communication environment between programs, the ability to model real-world processes in such an environment is lacking. For example, applications executing in the managed execution environment 106 are limited to an intermediate language to share functions or common object-oriented classes. The intermediate language has fixed parameters, arguments, or schemas or functions.

Referring again to FIG. 2, a user 204 (e.g., a human, an application program,an operating system, or the like) interacts with a computer 206 providing the workflow foundation framework. The computer 206 and processor associated therewith (not shown) have access to a memory area 208 storing continuation data 210 and one or more computer-readable components or modules that have computer-executable instructions for implementing the workflow foundation. The continuation data 210 includes an application state and a runtime state. In one embodiment, the application state includes a list of activity objects and indicates an activity status (e.g., with a reference to the activity tree) while the runtime state includes a program counter identifying an exception handler next scheduled for execution or otherwise indicates a scheduler queue status (e.g. the items in a queue associated with the scheduler). The continuations represented by the continuation data 210 generally represent an activity execution context or other state of the program fragment at a given point in time. The activity execution context is available independent of the stack associated with the physical thread from the managed execution environment 106.

In the embodiment of FIG. 2, the computer-executable components or modules include an automata module 212, an execution machine module 214, a continuation module 216, and a resumption module 218. The automata module 212, when executed by the computer 206, defines an automaton for association with an activity in a workflow. The defined automaton has a set of states associated therewith and one or more methods corresponding to each of the states. The execution machine module 214 executes a program fragment including the activity based on the automaton defined by the automata module 212. The continuation module 216 captures, responsive to receipt of a suspension signal directed to the program fragment being executed by the execution machine module 214, continuation data 210 of the program fragment and releases a resource associated with the program fragment. Operation of the continuation module 216 may be referred to as pickling the program fragment, evicting the program fragment, dehydrating the program fragment, and/or unloading the program fragment. For example, the continuation data is used to model one or more of the following: a control flow pattern, an iteration, a parallel foreach statement, a state machine, a page flow controller, a sequence generator, and another continuation.

When executed by the computer 206 or other computing device, the resumption module 218 restores, responsive to receipt of a resumption signal directed to the program fragment being executed by the execution machine module 214, the continuation data 210 for the program fragment captured by the continuation module 216. The execution machine module 214 resumes execution of the program fragment based on the restored continuation data 210.

For example, using the reference to the continuation, an execution handler (e.g., a method associated with an activity) may schedule more execution handlers (e.g., a composite activity may schedule the execution of its children). In one embodiment, the reference to the continuation includes the activity execution context as a direct or implicit argument. Compensation of the successfully completed activities may be executed in the future by re-invoking the persisted context and executing the compensator method of the activity instance within the context.

Any of the elements in FIG. 2, the other figures, and language herein constitute means for providing the meta-runtime and means for capturing a continuation associated with the program fragment.

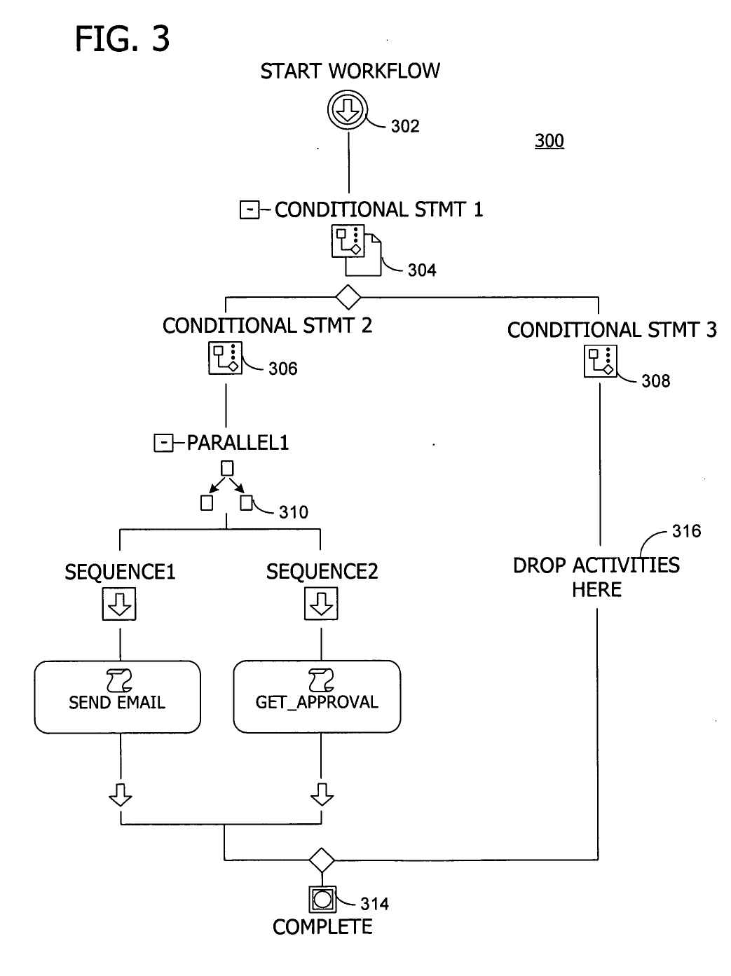

Referring next to FIG. 3, an exemplary workflow 300 is shown. In the example of FIG. 3, the workflow 300 is a workflow for processing a purchase order. The activities in the workflow may be sequenced such that some of the activities may be performed parallel to or simultaneous with other activities in the workflow 300, while some of the activities in the workflow 300 are executed after completion of other activities in the workflow 300. The workflow 300 starts from a starting point 302 such as the receipt of an order from a customer. The workflow 300 includes a conditional statement 304 (e.g., an IF statement or a WHILE statement) which branches into conditional statements 306 and 308 depending on the outcome of the condition in conditional statement 304. Following conditional statement 306, the workflow 300 includes a parallel structure 310 having two sequences to be executed asynchronously. In the example shown in FIG. 3, a “Send Email” activity and a “Get Approval” activity are processed in parallel before the workflow completes at 314.

After conditional statement 308, a “drop activities here” area 316 indicates that the activity writer or other user may add activities into the workflow 300 before the workflow completes at 314.

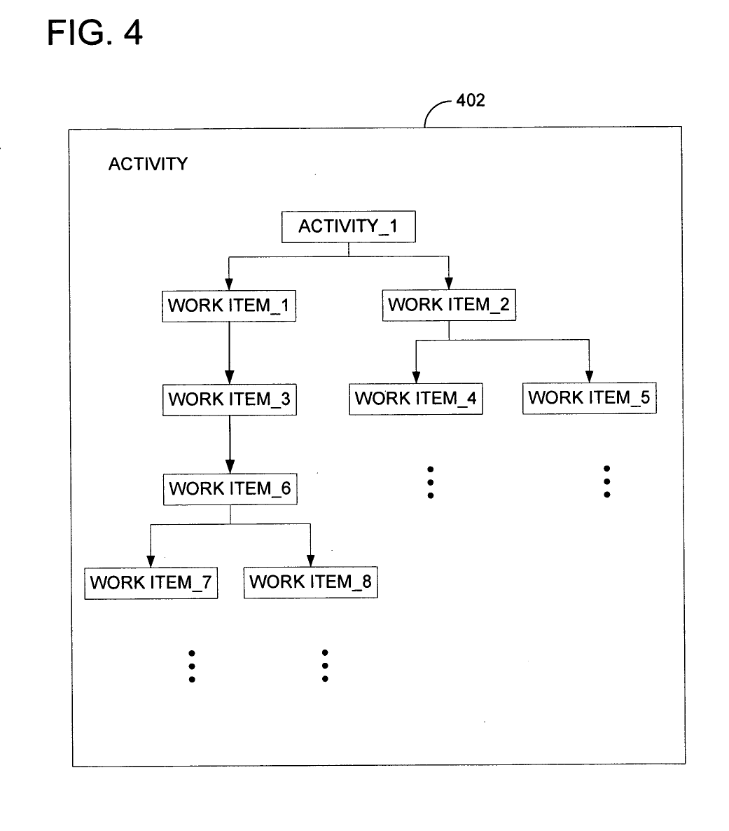

Referring next to FIG. 4, a block diagram illustrates a hierarchical structure 402 (e.g., a tree structure) of a workflow activity. Execution of the activity includes execution of the activity tree starting at the root of the tree. The activity may be configured by software code in any programming language. For example, the software code may represent business or application logic or rules written in a specific domain or execution environment. The activity may include one or more work items or other activities implementing the logic or rules. In the embodiment of FIG. 4, the activities and associated work items are arranged and executed according to the structure 402 or other execution sequence.

The meta-runtime engine defines a scope or boundary for each of the work items associated with an activity. This scope or boundary includes and exposes information (e.g., in the form of data, metadata, or the like) such as the shared data or resources to be accessed by the work items, associated properties, handlers, constraints, events, and the like.

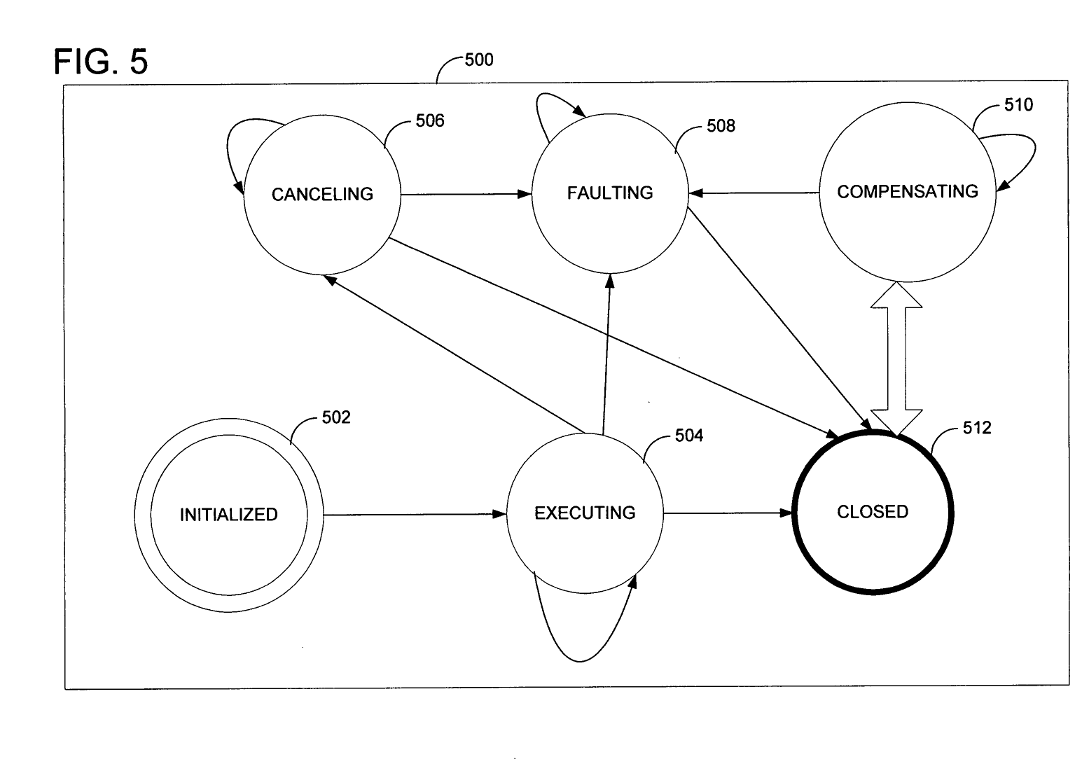

Referring next to FIG. 5, an exemplary state automaton defines a set of states through which an activity may transition. Generally, the state automaton 500 defines an execution lifetime for the activity. In the exemplary automaton of FIG. 5, the activity transitions through the defined set of states as the meta-runtime engine executes the activity and evaluates transitions conditions. The meta-runtime engine enforces execution of the activity per the abstract automaton. In one embodiment, the execution of an activity is performed in terms of the states in the automaton 500 and the specific possible transitions for each of the states.

One exemplary automaton includes an initialized state, an executing state, and a closed state. In the example of FIG. 5, the state automaton 500 includes an initialized state 502, an executing state 504, a canceling state 506, a faulting state 508, a compensating state 510, and a closed state 512. In another embodiment, one or more additional states may be defined in the state automaton 500 without departing from the scope of embodiments of the invention.

In general, the state automaton 500 has one or more transition conditions defining transition of the activity through the set of states. In one embodiment, if a first automaton is associated with a first activity and a second automaton is associated with a second activity, a transition condition of the first automaton of the first activity may be dependent on a current state of the second automaton of the second activity.

Further, the state automaton 500 may establish one or more relationships between work items or activities in a composite activity. For example, one of the relationship rules may include that, before transitioning methods or work items in the root node of the activity tree to the closed state 512, all the work items in the children nodes should be in the initialized state 502 or the closed state 512. Another rule may specify that the work item in the root node should be in the executing state 504 before transitioning the work items in the children node of the activity tree to the executing state 504.

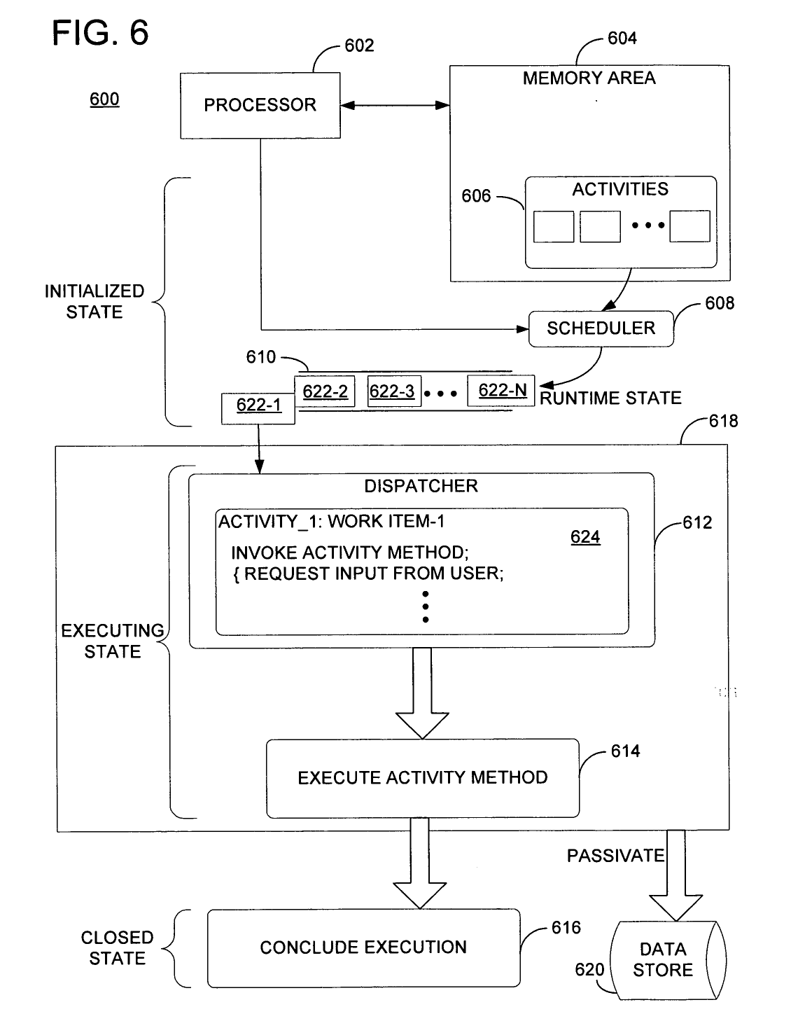

Referring next to FIG. 6, a diagram illustrates a system 600 for processing workflow activities according to an embodiment of the invention. The system 600 includes a processor 602, which may be a processing unit such as processing unit 102 in FIG. 1 or a collection of processing units. The system 600 also includes a storage or memory area 604 for storing data accessible by the processor 602. In one embodiment, the system 600 may be a computer having one or more processors or processing units (e.g., processor 602), a system memory (e.g., memory area 604), and other components to couple various system components including the processor 602 to the memory area 604.

For example, the memory area 604 stores a plurality of activities 606 for processing in a workflow (e.g., the workflow 300 in FIG. 3). Each of the plurality of activities 606 includes one or more work items, and the work items may be organized in a hierarchical structure such as a tree structure (see FIG. 4). In processing the plurality of activities 606, the processor 602 accesses or executes a scheduler 608. The scheduler 608 includes a queue 610 of work items (e.g., a workqueue) and a dispatcher 612 which dequeues the items and invoke the corresponding implementations that perform the work associated with the dequeued work item until the queue 610 is empty. Each unit of work in the queue 610 corresponds to a method implemented by an activity. The method may be referred to as the execution handler. A given activity's complete execution may span invocation and execution of a set of execution handlers enqueued in the queue 610 at an earlier point in time.

A state automaton such as state automaton 500 in FIG. 5 defines an execution flow for the work items (e.g., work items 622) in a workflow activity. The processor 608 accesses the work items in the plurality of activities 606 via a component or a set of computer-executable instructions such as the scheduler 608 to initialize the work items 622 and enqueue or store the work items 622 to a queue 610. For example, the work item 622-1, as illustrated in FIG. 6, is initialized and enqueued in the queue 610. The work item 622-1 is next dequeued or removed from the queue 610 by a dispatcher 612 before transitioning to an executing state (e.g., executing state 504 in FIG. 5) for execution.

In one example, the work item 622-1 includes an activity method or an activity operation 624, routine, or a collection of codes for performing a function of “requesting input from a user”. One or more other activity methods, activity operations, routines, or codes may be included in each of the work items 622 without departing from the scope of aspects of the invention.

As the dispatcher 612 dispatches the work items 622, the processor 602 executes the methods 624 in each of the work items 622 at 614. In the example of work item 622-1, the processor 602 may provide a user with a user interface (UI) to input the requested information or data. In another embodiment, the processor 602 may connect to or access an external data source for input. Upon completion of the activity method or activity operation 624, the processor 602 concludes execution of the work item 622-1 at 616.

Alternatively, the processor 602 may passivate or otherwise capture the executing state of work items (e.g., work item 622-1) at 618 to a data store 620 for subsequent retrieval and continued execution.

Depending on the parameters or conditions during the execution of the work item 622-1, the work item 622-1 may proceed to a canceling state (e.g., canceling state 506 in FIG. 5) or a faulting state (e.g., faulting state 508 in FIG. 5). In one embodiment, the work item 422-1 may proceed from the canceling state to the faulting state. In an alternative embodiment, a compensating state (e.g., compensating state 510 in FIG. 5) describes a set of operations or functions to be performed when a fault or exception has occurred.

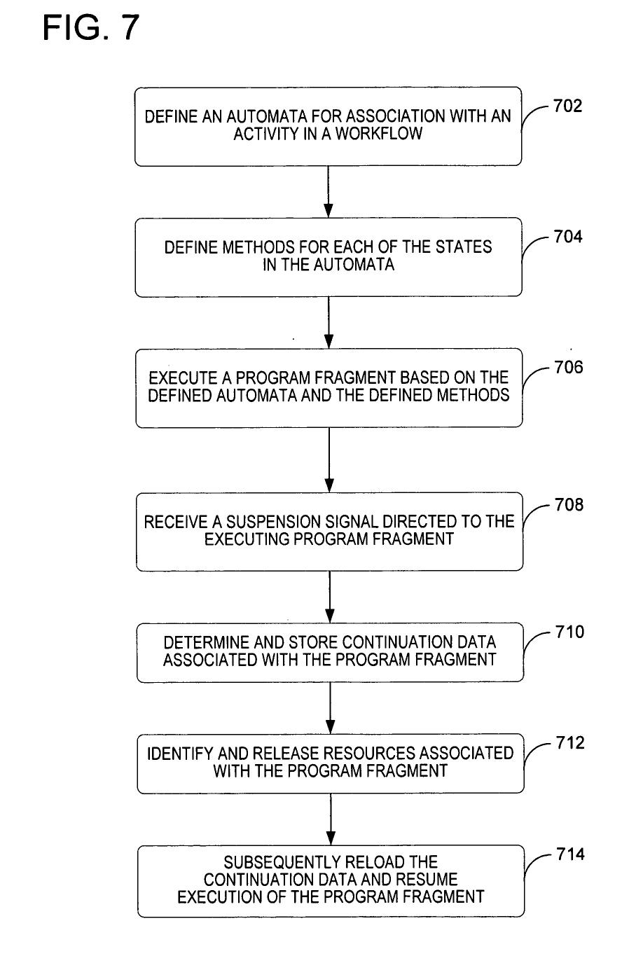

Referring next to FIG. 7, an exemplary flow chart illustrates operation of an abstract execution model for a continuation-based runtime. The method includes defining an automaton for association with an activity in a workflow at 702. The defined automaton has a set of states associated therewith and one or more transition conditions defining transition of the activity through the set of states. Prior to transitioning an activity from one state to another (or enabling the activity to transition), the method includes verifying the transition conditions. In one embodiment, the automaton is received from a user, application program, operating system, or other source.

The method defines one or more methods corresponding to each of the states in the automaton at 704. For example, the methods for an activity may be defined by a user, received by the runtime from the user, and associated with at least one of the states in the automaton associated with the activity. For example, the defined methods may be associated with a data structure representing the activity.

The meta-runtime engine, virtualizing a managed execution environment having a fixed functionality, executes a program fragment including the activity based on the defined automaton and the defined methods at 706. The method includes receiving a suspension signal directed to the executing program fragment at 708, determining continuation data associated with the program fragment responsive to the received suspension signal, and storing the determined continuation data in a memory area at 710. The continuation data represents a continuation of the program fragment. The method further includes identifying one or more resources associated with the program fragment and releasing the identified resources at 712.

In one embodiment, the execution of the program fragment is episodic with each episode persisted as a continuation. The continuation data represents an activity execution context that includes, in one embodiment, a runtime state associated with the meta-runtime engine and an application state associated with the program fragments. A data boundary for the continuation is defined by, for example, determining the extent, scoping, and binding of variables to the state in the ambient enclosing context(s).

Subsequently, a resumption signal may be directed at the program fragment when, for example, data is available for consumption by the program fragment. Responsive to this resumption signal, the method accesses the continuation data stored in the memory area and loads the accessed continuation data into an execution memory associated with the execution machine. The method resumes execution of the program fragment based on the loaded continuation data at 714. In general, these aspects of the method may be referred to as reactivation or restarting of the program fragment.

Computer 206 in FIG. 2 and processor 602 in FIG. 6 are examples of general purpose computing devices. In one embodiment of the invention, a computer is suitable for use in the other figures illustrated and described herein. The computer has one or more processors or processing units and a system memory. The computer typically has at least some form of computer readable media. Computer readable media, which include both volatile and nonvolatile media, removable and non-removable media, may be any available medium that may be accessed by computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory includes computer storage media in the form of removable and/or non-removable, volatile and/or nonvolatile memory. The computer may also include other removable/non-removable, volatile/nonvolatile computer storage media.

The computer may operate in a networked environment using logical connections to one or more remote computers, such as a remote computer. The remote computer may be a personal computer, a server, a router, a network PC, a peer device or other common network node, and typically includes many or all of the elements described above relative to computer.

Although described in connection with an exemplary computing system environment, including computer, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, organized into one or more components or program modules, executed by one or more computers or other devices. The data processors of the computer may be programmed by means of the computer-executable instructions stored at different times in the various computer-readable storage media of the computer. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. In operation, the computer executes computer-executable instructions such as those illustrated in the figures to implement aspects of the invention. Aspects of the invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services). The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols. The interfaces described herein may all be part of a single interface or may be implemented as separate interfaces or any combination therein. The interfaces may execute locally or remotely to provide functionality. Further, the interfaces may include additional or less functionality than illustrated or described herein.

The following examples further illustrate embodiments of the invention. A control flow is considered to be dynamic in nature when the number of children activities is not known at compile time. For instance, a composite activity that models a typical document review process sends messages to the reviewers by concurrently executing a set of primitive reviewer activities. However, the number of reviewers may not be known statically at the time the program is authored and hence the exact quantity of children of the composite activity cannot be configured at that time. In such cases, the composite activity is configured with a single reviewer activity acting as a template to generate a set of dynamic instances at execution time based on the actual reviewers available. Not only are the control flow aspects of these constructs dynamic in nature, but the runtime state, including its locality and bindings, is also dynamic. For instance, an activity that models a state machine is configured with a set of children activities that represent a state. Each state activity is a continuation that represents the state of the meta-program or the state machine frozen at a given point in time. The continuation may be executed multiple times and in arbitrary order by aspects of the invention.

Looping constructs may be viewed as special case of dynamic control flows. For example, the semantics of an activity that models a ForEach construct dictate that each iteration should create a distinct scope for the state that is contained within the ForEach activity. Scoping of the state involves the locality of the state, managing the referential integrity or binding of the states across scopes, and managing the extent or the lifetime of state enclosed in a given scope. With aspects of the invention, the program state is captured in terms of fields and dependency properties of activities in the program tree. In this manner, the notion of locals or temporary variables for activities that model looping constructs is created by effectively generating instances of activities dynamically. This captures the local state of the iteration based on the template activity that represents the body of the loop.

Further, unlike a program construct in a non-durable/non-transactional programming environment, activities may request to be compensated during subsequent program execution. For example, a successfully-completed iteration of a DoWhile activity may be compensated at a later point in its lifecycle if its parent activity faults. Aspects of the invention enable such compensation (e.g., implementing undo semantics) for each iteration by capturing and storing the execution state of the activity corresponding to each iteration as a continuation. The continuation representing the stored execution state may be invoked at a later time to make the original state of execution available when the compensating methods associated with any of the activities attempt to execute.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for modeling real-world processes in a workflow, said method comprising:
defining an automaton for association with an activity in a workflow, said defined automaton having a set of states associated therewith;
defining one or more methods corresponding to each of the states in the automaton, said defined methods being associated with a data structure representing the activity;
executing, by a meta-runtime engine virtualizing a managed execution environment having a fixed functionality, a program fragment including the activity based on the defined automaton and the defined methods;
receiving a suspension signal directed to the executing program fragment;
determining continuation data associated with the program fragment responsive to the received suspension signal, said continuation data representing a continuation of the program fragment;
storing the determined continuation data in a memory area;
identifying one or more resources associated with the program fragment; and
releasing the identified resources.

2. The method of claim 1, further comprising:
receiving a resumption signal directed to the program fragment;
accessing the continuation data stored in the memory area;
loading the accessed continuation data into an execution memory associated with the execution machine; and
resuming execution of the program fragment based on the loaded continuation data.

3. The method of claim 1, wherein the execution machine operates to virtualize one or more of the following aspects of the managed execution environment: a domain-specific op-code, a thread, a synchronization primitive, an execution machine, an object lifetime, a source format, an exception, a fault, fault propagation, and fault handling.

4. The method of claim 1, wherein defining the one or more methods comprises receiving, from a user, the methods for association with at least one of the states in the automaton associated with the activity.

5. The method of claim 1, wherein the automaton comprises one or more transition conditions defining transition of the activity through the set of states, and further comprising verifying the transition conditions prior to enabling the activity to transition through the states.

6. The method of claim 1, wherein one or more computer-readable media have computer-executable instructions for performing the method of claim 1.

7. A system for modeling real-world processes in a workflow, said system comprising:
a memory area for storing continuation data representing a continuation of a program fragment, said program fragment being associated with an activity in a workflow, said memory area further storing a meta-runtime engine for virtualizing a managed execution environment having fixed functionality, said meta-runtime engine having an execution machine representing an automaton having a set of states associated therewith, wherein one or more methods correspond to each of the states, wherein the methods are associated with a data structure representing the activity, said meta-runtime engine executing the program fragment based on the execution machine; and
a processor configured to execute computer-executable instructions for:
capturing the continuation data associated with the executing program fragment,
storing the captured continuation data in the memory area; and
releasing one or more resources associated with the program fragment.

8. The system of claim 7, wherein said capturing and said storing correspond to one or more of the following: pickling the program fragment, evicting the program fragment, dehydrating the program fragment, and unloading the program fragment.

9. The system of claim 7, wherein the meta-runtime engine uses one or more of the following from the managed execution environment: a thread, a stack, and a heap.

10. The system of claim 7, wherein the continuation data includes a program counter, said program counter identifying an exception handler next scheduled for execution.

11. The system of claim 7, wherein the memory area stores continuation data including an application state and a runtime state.

12. The system of claim 11, wherein the application state includes a list of activity objects.

13. The system of claim 11, wherein the runtime state includes a program counter

14. The system of claim 7, wherein the processor is further configured to execute computer-executable instructions for:
accessing the continuation data stored in the memory area;
loading the accessed continuation data into an execution memory associated with the meta-runtime; and
resuming execution of the program fragment based on the loaded continuation data.

15. The system of claim 14, wherein said loading and said resuming correspond to one or more of the following: reactivation and restarting.

16. The system of claim 7, further comprising means for providing the meta-runtime and means for capturing a continuation associated with the program fragment.

17. The system of claim 7, further comprising an automaton received from a user, wherein the meta-runtime engine executes the program fragment based on the received automaton.

18. The system of claim 7, wherein the automaton comprises one or more transition conditions defining transition of the activity through the set of states, further comprising a first automaton associated with a first activity and a second automaton associated with a second activity, wherein a transition condition of the first automaton of the first activity is dependent on a current state of the second automaton of the second activity.

19. One or more computer-readable media having computer-executable modules for modeling workflow passivation, said modules comprising:
an automata module for defining an automaton for association with an activity in a workflow, said defined automaton having a set of states associated therewith and one or more methods corresponding to each of the states;
an execution machine module for executing a program fragment including the activity based on the automaton defined by the automata module; and
a continuation module for capturing, responsive to receipt of a suspension signal directed to the program fragment being executed by the execution machine module, continuation data of the program fragment and releasing a resource associated with the program fragment, said continuation data representing a continuation of the program fragment.

20. The computer-readable media of claim 19, further comprising a resumption module for restoring, responsive to receipt of a resumption signal directed to the program fragment being executed by the execution machine module, the continuation data for the program fragment captured by the continuation module, wherein the execution machine module resumes execution of the program fragment based on the restored continuation data.
